(19) United States
(12) Patent Application Publication
(10) Pub. No.: US 2008/0195402 A1
(43) Pub. Date: Aug. 14, 2008

(54) METHOD AND APPARATUS FOR DETERMINING OPTIMAL PENALTY CREDITS ON E-COMMERCE OF I.T.-RELATED BUSINESS-TO-BUSINESS SERVICES

(75) Inventors: Parijat Dube, Yorktown Heights, NY (US); Giuseppe Andrea Paleologo, Bronx, NY (US); Laura Wynter, Chappaqua, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: INTERNATIONAL BUSINESS MACHINES CORPORATION, Armonk, NY (US)

(21) Appl. No.: 11/672,537

(22) Filed: Feb. 8, 2007

(51) Int. Cl. G06Q 99/00

(52) U.S. Cl. 705/1

(57) ABSTRACT

A method of establishing business contracts with penalty credits for service level agreement violations, including determining business goals of a customer, determining business goals of a provider, determining benefits and losses of the customer as function of a service offered by the provider, determining benefits and losses of a provider as a function of the service offered to the customer, determining a type of service level agreement metric to be monitored and measured, determining an interval over which penalties are assessed, determining a particular target value of the service level agreement metric, determining a means of evaluating the service level agreement metric, and computing an optimal penalty credit structure achieving the business goals of the customer.

### BACKGROUND OF THE INVENTION

1. Field of the Invention

The present invention relates to a method and apparatus for determining penalty credit structures. More particularly, the present invention relates to a method and apparatus for determining customer-supplier optimal penalty credit structures.

2. Description of the Related Art

Service-level agreements (SLA) are essential components of the customer-supplier relationship in such areas as e-commerce, web services, and many other areas of business transformation outsourcing (BTO) and business-to-business IT-related services. SLAs stipulate the quality of service agreed upon between customer and supplier in contractual terms.

Typically, SLAs define a number of metrics which are to be monitored throughout the duration of the contract. A typical metric in e-commerce or web services is the response time of requests, or some function thereof (maximum response time over an interval, percentile of the response time distribution over a specified period, etc). In capacity on demand, or software as a service (SAAS), the metrics may include average throughput, CPU cycles, or software licenses made available to a customer; in business transformation outsourcing, application-specific metrics are defined as those of relevance to the business which is outsourced. The metrics which are defined must be able to be measured throughout the duration of the contract; usually some form of average and possibly other moments are compiled on a periodic basis.

In addition to stipulating the metrics which are to be monitored and the frequency of their evaluation, SLAs define the levels of those metrics which should be achieved by the supplier. For example, in the case of the maximum acceptable response time metric, the contract will define what that response time threshold should ideally be. Similarly, a minimum necessary CPU availability level or number of concurrent software licenses available may be stipulated as part of a capacity-on-demand, or software-as-a-service (SAAS) contract.

While much attention is given to how to price service contracts, and how to measure service levels from an Information Technological (IT) point of view, little is known about how to effectively “price” penalties, or credits, for not meeting those service level targets. However, setting the metrics and target levels of the SLAs is critical to the profitability of the contract for the supplier. Similarly, setting the levels properly is essential for the acceptable functioning of the contract from the customer's point of view.

Existing solutions for setting a penalty in SLA terms in e-commerce and IT-related business-to-business services rely on ad-hoc definitions of penalty credits and often result in one of two undesirable outcomes. First, in some cases the penalty credit structure favors the supplier to the detriment of the customer. Customer satisfaction suffers when SLA targets are not met, but customer remuneration by the supplier through penalty credit is insufficient to stem losses that the customer experiences from its own clients. Second, in other cases, the penalty credit structure is overly generous and results in an excessively costly contract for the supplier to honor. Typically, these ad-hoc penalty structures take the form of a dollar value per unit of the SLA metric, such as one dollar per minute of average delay beyond the stipulated threshold.

It is surprisingly difficult to ensure the profitable functioning of business-to-business (B2B) services when SLA and penalty structures are in place. This is because, whereas prices for service are judiciously studied and calculated so as to ensure profitability, the payment of penalties can negate the profit achieved. Setting penalty values too low, however, dissuades potential clients from engaging in a new or untested B2B service. To attract and reassure potential clients, penalty values are often set high. A vicious cycle is hence created: so as to achieve the SLA guarantees and avoid paying the penalties, suppliers may be forced to increase their costs (increase capacity or human resources). However, the price to the customer must then be increased or again profits decreased. Many B2B suppliers focus on reducing costs through various means of automation. However, one often neglected means for combating the downward pressure on profits is to address the penalty structures directly. This invention presents a means for devising penalty structures that respond both to supplier and customer objectives of profitability and quality.

### SUMMARY OF THE INVENTION

In view of the foregoing and other exemplary problems, drawbacks, and disadvantages of the conventional methods and structures, an exemplary feature of the present invention is to provide a method and system for determining penalty credit structures, based on characteristics of the service provider's business, profitability, and desired SLA metric and levels, as well as, in some cases, the customer's own business. In addition, the invention allows for the possibility to perform an arbitrage of limited capacity across the service provider's customers, in a way which is most beneficial to the service provider, and using the penalty credit structure as a lever.

In accordance with a first aspect of the present invention, a method of establishing business contracts with penalty credits for service level agreement violations, includes determining business goals of a customer, determining business goals of a provider, determining benefits and loses of the customer as function of a service offered by the provider, the determining comprising assessing a revenue that the provider gains from the customer and non-monetary benefits that the provider receives from the customer, determining benefits and losses of a provider as a function of the service offered to the customer, determining a type of service level agreement metric to be monitored and measured, determining an interval over which penalties are assessed, determining a particular target value of the service level agreement metric, determining a means of evaluating the service level agreement metric, computing an optimal penalty credit structure achieving the business goals of the customer, the computing the optimal penalty credit structure characterized as the function Θ_{c} that maximizes U_{c}(x, τ, Θ) and computing an optimal penalty credit structure achieving the business goals of the provider, the computing the optimal penalty credit structure characterized as the function Θₚ that maximizes Uₚ(x, τ, Θ), wherein:
x=offered service level
τ=target service level
Uₚ(x, τ, Θ(x, τ))=utility accrued by the service provider for providing service level x to the customer
U_{c}(x, τ, Θ(x, τ))=utility accrued by the customer when receiving service level x from
Θ(x, τ)=penalty paid by the service provider for providing service level x to the customer

The present invention defines a class of optimal penalty structures, including provider-optimal penalty structures, customer-supplier optimal penalty structures, and variants of those, and provides a methodology through which to determine them.

The invention includes several possible embodiments of this concept, which differ according to the type of the degree and type of characterization of the service provider's business and of the customers' business, and each embodiment results in different versions of the methodology.

The present invention considers both the profitability requirement of the supplier as well as means for ensuring customer satisfaction and thus proposes a methodology for determining customer-supplier optimal penalty credit structures.

The use of these structures, updated so as to reflect current operating and market conditions, can substantially increase the net profits accrued to the supplier as well as, in many cases, increasing satisfaction with the service by the customer. The key is in modeling explicitly the controls available to the supplier through the form and characteristics of the penalty structures, in conjunction with the expected customer response to the B2B service and to the penalty structure.

The end result is that, even in situations in which costs can no longer be reduced, additional profits can be gained by the supplier.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates customer revenue and provider penalty as a function of throughput level x; and

FIG. 2 illustrates an apparatus for determining customer-supplier optimal penalty credit structures in accordance with an exemplary aspect of the present invention.

### DETAILED DESCRIPTION OF EXEMPLARY EMBODIMENTS OF THE INVENTION

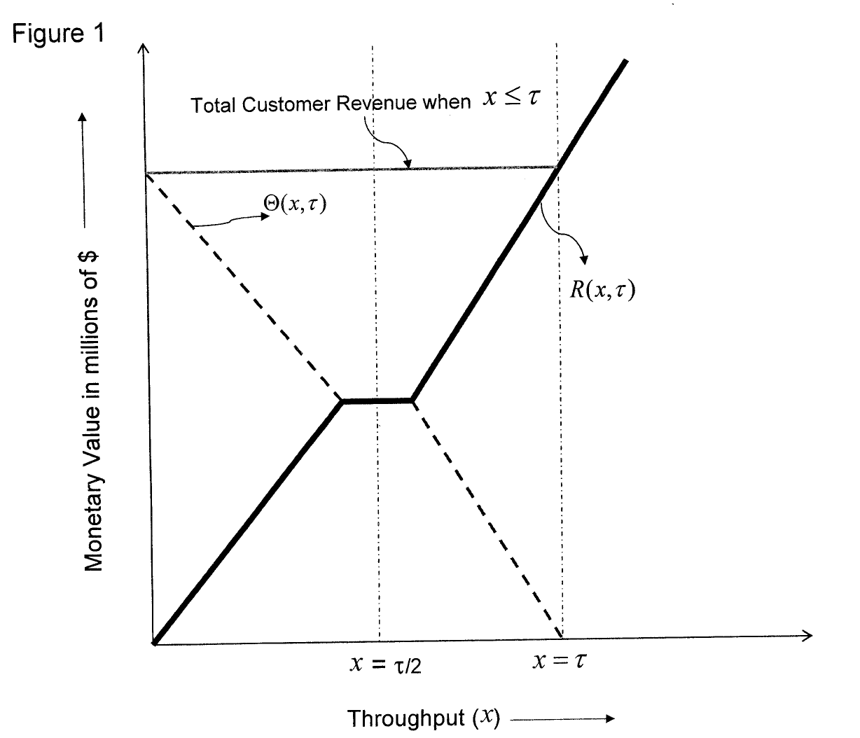

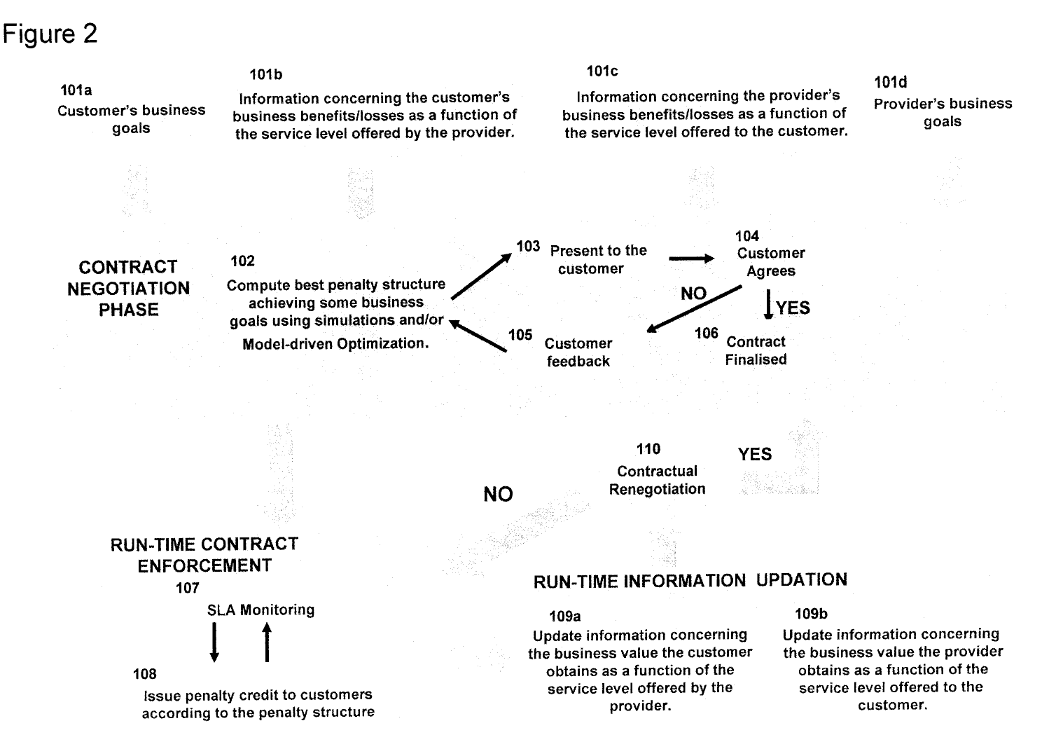

Referring now to the drawings, and more particularly to FIGS. 1 and 2, there are shown exemplary embodiments of the method and structures according to the present invention.

The present invention is directed to a method of determining optimal penalty credit structures and their parameters, taking into account the characteristics of the service provider's business as well as the customer's.

The first step in the method is to agree upon the type of SLA metric to be monitored and measured, as well as the interval over which penalties are assessed (e.g., every week, month, every quarter, etc), a particular target value of the metric(s), and a means of evaluating the metric (average over the interval, maximum, percentile, etc.). Then, the optimal penalty credit value is calculated as a function of different parameters.

In accordance with one embodiment of the invention, the invention takes two primary components in addition to the definition of the SLA metric(s) to be monitored and the time interval over which it is to be assessed.

The first is an assessment of the service provider's benefit as a function of the IT service provided to one or more customers. This assessment may involve the unit price or price structure charged to the customer, and hence incorporate an assessment of the revenue that the service provider gains from the customer, or it may involve non-monetary benefits that the service provider received from the customer (e.g., customer goodwill, etc.).

The second component is an assessment of the benefit that the customer attains from the service provided. This benefit may be related directly to the customer's own revenue, as a function of the IT-related service provided by the provider. Alternatively, it may be a benefit related only to the particular SLA metric defined in the contract.

First, the method lets:
x=offered service level
τ=target service level
Uₚ(x, τ, Θ(x, τ))=utility accrued by the service provider for providing service level x to the customer
U_{c}(x, τ, Θ(x, τ))=utility accrued by the customer when receiving service level x from the provider
F(x, τ)=monetary measure of benefit accrued by the service provider for providing service level x to the customer
Θ(x, τ)=penalty paid by the service provider for providing service level x to the customer
R(x, τ)=monetary measure of benefit accrued by the customer with service level x

Then a provider-optimal penalty structure is characterized as the function Θₚ that maximizes Uₚ(x, τ, Θ) whereas a customer-optimal penalty structure can be characterized as the function Σ_{c} that maximizes U_{c}(x, τ, Θ). One way to view the provider utility as Revenue earned from the customer −Penalty paid to the customer, and analogously customer utility as Revenue earned from end-users +Penalty paid by the provider. Thus,

Uₚ(x, τ, Σ)=F(x, τ)−Σ(x, τ),

and

U_{c}(x, τ, Θ)=R(x,τ)+Θ(x,τ).

Several other exemplary embodiments of the present invention define special cases of these two utility components.

In accordance with certain exemplary embodiments, the service provider obtains an estimate of the value of the service to the customer. In some cases, such as on demand IT business services, a customer can provide this to the service provider during a contract negotiation phase. In other cases, the provider can estimate it for several typical customer types. This value represents how the customer's revenue is predicted to increase with the IT service in question. (As an example of this, consider an Internet Service Provider (ISP) who leases capacity from the service provider. It is straightforward for the ISP to assess how its revenue increases as the amount of capacity or throughput made available to it increases). In this case, the target value for the service may be the value below which the customer does not obtain sufficient revenue from its own clients.

Based on the above-described function of the value of the service, and the target value, the service provider can construct a penalty structure which is customer-provider optimal in the sense that it compensates the client up to a predefined level so that the customer makes the minimum revenue it needs and considers the provider's benefit from both price paid by the customer as well as potentially costs and other non-monetary benefits.

For example, the service provider can compensate the customer, if the service level falls below τ, by paying a penalty equal to the loss in revenue due to offered service level being below the agreed upon target.

Θ(x,τ)=max{R(τ,τ)−R(x,τ),0}.

In other words, the service provider, in this case, absorbs the loss experienced by the customer in the event that the service level falls below the threshold allowing the customer a minimal level of profitability. Since the penalty structure here is fixed, the provider's utility can be expressed as:

F(x,τ)−max{R(τ,τ)−R(x,τ),0} (1)

When the service provider has the ability to choose the level of throughput or service provided to the customer (i.e., x), the service provider can maximize its own benefit, subject to limits that it has on available resources by maximizing (1) with respect to x.

An illustration of one form of a penalty function is provided in FIG. 1. The x-axis represents a performance metric (in this case it is throughput, and is referred to by x). The dashed curve (Θ) represents the amount of the penalty paid by the supplier to the customer, as the performance metric improves from poor (throughput of zero, in this example) to a threshold value τ. The full curve (R) represents the monetary benefit accrued by the customer as a function of service level x. The curve describing the benefit to the customer as a function of the performance metric may be directly obtained from the customer or may be suggested to the customer by the supplier, for example, from a palette of possible curves.

The value R(x), in FIG. 1 at x=τ, represents the value at which the penalty paid to the customer is zero. In other words, the service level provided will allow the customer to operate profitably. The penalty curve in this example allows the provider to assure the customer that he/she will be able to operate profitably, by compensating the customer to that level if service provided is insufficient to permit profitable functioning of the customer's business. Hence, the penalty curve can be obtained by subtracting the value to the customer at each level of the performance metric from the minimum level of profitability of the customer, until the penalty goes to zero. The penalty paid then remains at zero in this case for better levels of service than that threshold value, τ, in this example.

In accordance with this embodiment of the invention, the service provider determines a penalty structure in isolation for each customer and using only deterministic, average information about the customer and the provider's service. In other exemplary embodiments of the invention, the service provider performs an analogous computation but takes into account more than one customer using the service provider's resources, hence performing an arbitrage across the customers' use.

In accordance with this exemplary embodiment, the service provider determines the penalty level to offer to the customer in much the same way as above, but takes into account more than one customer sharing the same set of resources. In this way, the service provider can perform an arbitrage across the customers, offering more capacity to one at the possible detriment of another, so as to gain more revenue.

An example scenario is when the provider and customer agree to define penalty as a proportion of the revenue accrued by the customer. Let θᵢ be this penalty proportion. Then, the utility obtained by the service provider from the ith customer when offered service level xᵢ can be expressed as

Uᵢ(xᵢ,τᵢ,θᵢ)=Fᵢ(xᵢ,τᵢ)−θᵢ*Rᵢ(xᵢ,τᵢ),

subject to any constraints on the available resources, x, and/or on the minimum value of xᵢ specified by the customer and/or on the maximum or minimum limits of the penalty proportions.

Thus, the aggregate benefit that the service provider can accrue from S customers can be expressed as:

$${\sum }_{i = 1 , … , S} {U}_{i} ( {x}_{i} , {τ}_{i} , {θ}_{i} ) , \qquad ( 2 )$$

where the notation Σ_{i=1 . . . s} indicates that the sum is taken over S customers, and the index or parameter i indicates that the value should be taken for the ith customer. The service provider looks for the vectors θ={θᵢ, i=1, . . . ,S} and x={xᵢ,i=1, . . . , S} that maximizes (2).

Accordingly, the method allows the decision to favor some customer's allocations over others and this will be reflected by more or less penalty being paid by the service provider, in a way that improves the service provider's revenue. Then, the following embodiment uses queuing analysis to predict more accurately the expected level of service, and hence obtain a better penalty structure.

The method uses queuing models to express SLAs in terms of system parameters which include the parameters in the customer's choice model, the target SLA level desired, the price charged by the provider, the market size etc.

In the following example, a specific SLA is considered, namely, the perceived delay by a client of the customer. Due to randomness in demand it is impossible to always satisfy target levels for different customers. Thus, during periods of high demand some clients of the customer may perceive delay that exceeds the target level and hence the provider makes provisions to give penalty credit to the customer as his/her clients are affected. In this embodiment the credit is some percentage of the price charged by the provider from the customer for the particular service.

Next, the revenue a service provider can expect in such a scenario is determined and what strategy it should adopt to maximize its revenue. Let p be price charged by the provider and the target delay be d. The provider advertises that its offering will provide a delay not exceeding d to almost all the clients of the customer and for those fraction of clients who experience delay greater than d, the customer shall be credited with an amount proportional to the price for service charged by the provider.

Then, the penalty credit paid by the service provider to the customer for providing delay greater than d to a client is given by θ*p. Let the customers associate a (dis)utility to the service offering by the provider and let the utility function be a function of the penalty credit, θ*p, and the SLA, d. Utility functions are used to model the value of a service proposition to a customer. The utility can be expressed using different types of model: logit choice model, linear models ect. Let us consider a case with linear utility function of the form

d−αθp,

Where α is taken to be a random variable with distribution F modeling the customer's tradeoff between delay and penalty credit. The customers also put a maximum threshold, γ on the utility function and hence it results that only those customers for which

α>α* with α*=(d−γ)/θp

shall enter into contract with the service provider. Thus the fraction of customers entering into contract with the supplier is 1−F(□*).

The total market size of the customers is represented as B and the expected number of clients at a customer is represented as L. The provider's utility is then expressed as:

$$\begin{matrix}{U}_{p} ( x , τ ) = F ( x , τ ) - {θ}^{*} R ( x , τ ) \\ = p ( 1 - F ( {α}^{*} ) ) BL - θ pP ( W > d ) ( 1 - F ( {α}^{*} ) ) BL ,\end{matrix}$$

where W is the wait time perceived by a client and P(W>d) is the fraction of customers who experience a delay greater than d. The clients of different customers can be served in different manners depending upon the scheduling at the provider.

For the basic case with no priority among different customers, if one assumes that the provider has a total capacity c and process request by clients of different customers in a First In First Out (FIFO) manner. Further, if the client arrival process for each customer can be modeled as a Poisson process (implying the aggregate client arrival process at the provider is a Poisson process), then the method basically ends up with a M/M/1 queuing model for the provider and from classical queuing results:

P(W>d)=exp(−(c−BLF(α*))d).

Hence, the revenue of the service provider can be expressed as a function of the penalty proportion and can be maximized by solving:

$${max}_{θ} pBL ( 1 - F ( {α}^{*} ) ) [ 1 - θexp ( - ( c - BLF ( {α}^{*} ) ) d ) ] ,$$

subject to constraints on θ.

An apparatus to implement the method of the invention is illustrated in FIG. 2.

The method and apparatus of the present invention can be used with a hardware configuration of an information handling/computer system, which preferably has at least one processor or central processing unit (CPU).

The CPUs are interconnected via a system bus to a random access memory (RAM), read-only memory (ROM), input/output (I/O) adapter (for connecting peripheral devices such as disk units and tape drives to the bus), user interface adapter (for connecting a keyboard, mouse, speaker, microphone, and/or other user interface device to the bus), a communication adapter for connecting an information handling system to a data processing network, the Internet, an Intranet, a personal area network (PAN), etc., and a display adapter for connecting the bus to a display device and/or printer (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the software and hardware above, to perform the method of the invention.

This signal-bearing media may include, for example, a RAM contained within the, as represented by the fast-access storage for example. Alternatively, the instructions may be contained in another signal-bearing media, such as a magnetic data storage diskette, directly or indirectly accessible by the CPU. Whether contained in the diskette, the computer/CPU, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A method of establishing business contracts with penalty credits for service level agreement violations, comprising:
determining business goals of a customer;
determining business goals of a provider;
determining benefits and loses of the customer as function of a service offered by the provider,
determining benefits and losses of the provider as a function of the service offered to the customer;
determining a type of service level agreement metric to be monitored and measured;
determining an interval over which penalties are assessed;
determining a particular target value of the service level agreement metric;
determining a means of evaluating the service level agreement metric;
computing a penalty credit structure achieving said business goals of the customer, said computing the optimal penalty credit structure characterized as the function Θ_{c} that maximizes U_{c}(x, τ, Θ) and
computing a penalty credit structure achieving said business goals of the provider, said computing the optimal penalty credit structure characterized as the function Θₚ that maximizes Uₚ(x, τ, Θ),
wherein:
x=offered service level
τ=target service level
Uₚ(x, τ, Θ(x, τ))=utility accrued by the service provider for providing service level x to the customer
U_{c}(x, τ, Θ(x, τ))=utility accrued by the customer when receiving service level x from the provider
F(x, τ)=monetary measure of benefit accrued by the service provider for providing service level x to the customer
Σ(x, τ)=penalty paid by the service provider for providing service level x to the customer
R(x, τ)=monetary measure of benefit accrued by the customer with service level x

2. The method according to claim 1, further comprising:
presenting the optimal penalty credit structures to the customer;
negotiating and finalizing a contract based on the optimal penalty credit structures;
enforcing the contract, said enforcing comprising:
monitoring the service level agreement; and
issuing penalty credits to customers in violation of the service level agreement based on the optimal penalty credit structures.

3. The method according to claim 2, further comprising:
updating information concerning said benefits and loses of the customer as function of a service offered by the provider; and
updating information concerning said benefits and losses of a provider as a function of the service offered to the customer.
